(19) United States
(12) Patent Application Publication
(10) Pub. No.: US 2011/0281123 A1
(43) Pub. Date: Nov. 17, 2011

(54) Curable Silicone Rubber Composition

(76) Inventors: Hiroaki Yoshida, Ichihara-shi (JP); Nozomi Ishigami, Ichihara-shi (JP); Chiichiro Hasegawa, Awara-shi (JP); Makoto Yoshitake, Funabashi-shi (JP)

(21) Appl. No.: 13/147,003

(22) PCT Filed: Jan. 29, 2010
(86) PCT No.: PCT/JP2010/051663

§ 371 Date: Jul. 29, 2011

(30) Foreign Application Priority Data
Feb. 2, 2009 (JP) JP2009-022013
Jan. 29, 2010 (JP) PCT/JP2010/051663

(51) Int. Cl. C09D 183/05; B32B 27/06; B05D 3/10; C08L 83/05

(52) U.S. Cl. 428/447; 525/100; 524/506; 427/387

(57) ABSTRACT

A curable silicone rubber composition comprises (A) an alkenyl-containing organopolysiloxane comprising (A-1) a dialkylpolysiloxane that has an average of at least two alkenyl groups in each molecule and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl and that contains the alkenyl group in the range from more than 2.5 mass % to not more than 5.0 mass %; (B) an organopolysiloxane that contains the silicon-bonded hydrogen atom; and (C) a hydrosilylation reaction catalyst in a catalytic quantity. The curable composition provides a cured silicone material that has a hardness of not more than 75 and an elongation of at least 35%. Also, a composite in which the cured silicone material provided by the thermosetting of the curable composition is integrated into a single article with a substrate.

### TECHNICAL FIELD

The present invention relates to a curable silicone rubber composition that provides a flexible cured silicone product. The present invention more particularly relates to a curable silicone rubber composition that contains a resin-form organopolysiloxane, that exhibits an excellent surface releasability, and that can form a flexible cured silicone layer on a substrate.

### BACKGROUND ART

Curable silicone rubber compositions that contain a resin-form organopolysiloxane and that provide a cured silicone product are known. For example, JP 2005-042099 A (Equivalent to US 2005-0006794 A1) describes a silicone rubber composition comprising an organopolysiloxane that has at least two aliphatically unsaturated bonds in each molecule; an organopolysiloxane having a resin structure and comprising the SiO₂ unit, an R₃SiO_{0.5} unit having 2-3 vinyl groups, and an R₃SiO_{0.5} unit having 0-1 vinyl group, wherein the non-vinyl R in these formulas is monovalent hydrocarbyl that does not contain an aliphatically unsaturated bond, e.g., methyl and so forth; an organohydrogenpolysiloxane that has at least two silicon-bonded hydrogen atoms in each molecule; and a platinum group metal-based catalyst. In the following, the SiO₂ unit is referred to as the Q unit and the R₃SiO_{0.5} unit is referred to as the M unit.

The polyorganosiloxane composition described in JP 2006-335857 A provides a transparent cured material and comprises a straight-chain polyorganosiloxane containing silicon-bonded alkenyl and having a viscosity at 23° C. of 10 to 10,000 mm²/s; a branched polyorganosiloxane comprising the Q unit, an M unit having one vinyl group, and an M unit that does not contain an aliphatically unsaturated bond; a polyalkylhydrogensiloxane comprising the Q unit, an M unit having one silicon-bonded hydrogen atom, and an M unit that does not contain silicon-bonded hydrogen; and a platinum group metal compound.

The curable silicone rubber composition described in JP 2007-131694 A (equivalent to US2009-0118441 A1) comprises at least a diorganopolysiloxane that has at least two alkenyl groups in each molecule; at least two resin-form organopolysiloxanes that have different mass-average molecular weights, each comprising the Q unit, an M unit having one vinyl group, and an M unit that does not contain an aliphatically unsaturated bond; an organopolysiloxane that has at least two silicon-bonded hydrogen atoms in each molecule; and a hydrosilylation reaction catalyst.

However, the cured silicone materials provided by the cure of such compositions are hard and exhibit a poor flexibility and are prone to breakage during mold-based molding and during component assembly processes, and it has also not been possible to use them in applications that demand bendability due to use in a flexed or bent condition. Another deficiency has been the loss of substrate flexibility that occurs when these cured silicone materials are made into composites that incorporate a flexible substrate.

A silicone rubber composition for fixing roll applications is described in JP 07-041679 A (equivalent to U.S. Pat. No. 5,455,313 A); this silicone rubber composition comprises a mixture of two alkenyl-functional diorganopolysiloxanes that have specific viscosities, a specific organosiloxane resin, an organopolysiloxane that has silicon-bonded hydrogen, and a platinum catalyst, but does not contain an inorganic filler. While this composition can form a flexible surface release layer that has a lower hardness than the fluororesin coatings used for prior rolls, the surface releasability of the cured material from this silicone rubber composition is not satisfactory.

### PATENT REFERENCES

Patent Reference 1: JP 2005-042099 A
Patent Reference 2: JP 2006-335857 A
Patent Reference 3: JP 2007-131694 A
Patent Reference 4: JP 07-041679 A

### DISCLOSURE OF INVENTION

An object of the present invention is to provide a curable silicone rubber composition for forming a flexible cured silicone material that exhibits an excellent surface releasability.

The curable silicone rubber composition of the present invention characteristically comprises
(A) 100 mass parts of an alkenyl-containing organopolysiloxane comprising
   (A-1) a dialkylpolysiloxane that has an average of at least two alkenyl groups in each molecule and a viscosity at 25° C. of 300 to 100,000 mPa·s, at 65 to 90 mass % of component (A), and
   (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl and that contains the alkenyl group in the range from more than 2.5 mass % to not more than 5.0 mass %, at 10 to 35 mass % of component (A);
(B) an organopolysiloxane that has an average of at least two silicon-bonded hydrogen atoms in each molecule wherein the silicon-bonded groups other than the silicon-bonded hydrogen are C₁₋₁₀ alkyl, in an amount that provides 0.5 to 5 moles silicon-bonded hydrogen in this component per 1 mole of the total alkenyl in component (A); and
(C) a hydrosilylation reaction catalyst in a catalytic quantity,
   and provides a cured silicone material that has a hardness measured using the type A durometer specified in JIS K 6253 of not more than 75 and an elongation as specified in JIS K 6251 of at least 35%.

The ratio of the total number of moles of R¹₂R²SiO_{1/2} and R¹₃SiO_{1/2} units to 1 mole of the SiO_{4/2} unit in the aforementioned component (A-2) is preferably in the range from 0.5 to 1.4. The aforementioned component (B) preferably comprises
(B-1) an organopolysiloxane that contains at least 0.7 mass % silicon-bonded hydrogen and that comprises the SiO_{4/2} unit and HR³₂SiO_{1/2} unit wherein R³ is C₁₋₁₀ alkyl, at 50 to 100 mass % of component (B), and
(B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B).

The curable silicone rubber composition described above is useful as a cured coating-forming coating agent.

The cured silicone composite of the present invention characteristically comprises a cured silicone layer that forms a single article with a substrate wherein the cured silicone layer is provided by the thermosetting of a curable silicone rubber composition as described above. This cured silicone composite can be obtained by coating a curable silicone rubber composition as described above on a substrate and then carrying out thermosetting to form a cured silicone layer on the surface of the substrate. The substrate referenced in the preceding is preferably a silicone elastomer.

The aforementioned cured silicone composite can be exemplified by a roller or belt characterized by the formation of a cured silicone layer on the peripheral surface of a silicone elastomer layer that is formed on the periphery of a core or belt substrate wherein the cured silicone layer is provided by the thermosetting of the curable silicone rubber composition. This roller or belt can be obtained by coating the aforementioned curable silicone rubber composition on the peripheral surface of a silicone elastomer layer formed on the periphery of a core or belt substrate and then thermosetting to form a cured silicone layer on the peripheral surface of the silicone elastomer layer.

The curable silicone rubber composition of the present invention characteristically provides a flexible cured silicone material that exhibits an excellent surface releasability because the composition comprises a special alkenyl-functional dialkylpolysiloxane and a special alkenyl-functional, resin-form organopolysiloxane. Because it is flexible, the cured silicone material provided by the cure of this composition characteristically resists breakage during mold-based molding and component assembly processes and thus exhibits an excellent moldability and handling characteristics, and can also be used in applications that demand bendability, for example, use in a flexed or bent condition. The curable silicone rubber composition of the present invention is useful as a cured coating-forming coating agent and can characteristically form a composite in which it is tightly integrated into a single article with a substrate such as a silicone elastomer. Such a cured silicone composite characteristically has a flexible surface release layer on the surface of a substrate.

### BEST MODE FOR CARRYING OUT THE INVENTION

The alkenyl-containing organopolysiloxane that is component (A) is the base component of the present composition and comprises (A-1) a dialkylpolysiloxane that has an average of at least two alkenyl groups in each molecule and a viscosity at 25° C. of 300 to 100,000 mPa·s, at 65 to 90 mass % of component (A), and (A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl and that contains the alkenyl group in the range from more than 2.5 mass % to not more than 5.0 mass %, at 10 to 35 mass % of component (A).

Component (A-1) has an average of at least two alkenyl groups in each molecule. Component (A-1) has a substantially straight chain molecular structure, but a portion of the molecular chain may be somewhat branched. The alkenyl in component (A-1) can be exemplified by vinyl, allyl, isopropenyl, butenyl, hexenyl, and cyclohexenyl wherein vinyl is preferred. The bonding position for this alkenyl is not limited and may be the terminal position on the molecular chain, side chain position on the molecular chain, or both terminal position and side chain position on the molecular chain. The alkyl in component (A-1) can be exemplified by C₁₋₁₀ alkyl such as methyl, ethyl, propyl, cyclopentyl, cyclohexyl, and so forth, wherein methyl is preferred.

The viscosity of component (A-1) at 25° C. is in the range from 300 to 100,000 mPa·s and preferably is in the range from 1,000 to 60,000 mPa·s and more preferably is in the range from 10,000 to 50,000 mPa·s. When component (A-1) is a mixture of two or more alkenyl-functional dialkylpolysiloxanes, the viscosity of this mixture at 25° C. is preferably in the range from 1,000 to 50,000 mPa·s, but viewed from the standpoint of achieving an additional increase in the surface releasability, this is preferably an alkenyl-functional dialkylpolysiloxane mixture in the viscosity range from 300 to 100,000 mPa·s. The reasons for the preceding are as follows: when the viscosity of component (A-1) at 25° C. is less than the lower limit cited above, the cured silicone material provided by the cure of the present composition tends to have an unsatisfactory flexibility; when, on the other hand, the viscosity of component (A-1) at 25° C. exceeds the upper limit cited above, the present composition has an excessively high viscosity and the handling characteristics tend to decline and the surface releasability of the cured silicone material provided by the cure of the present composition tends to deteriorate.

This component (A-1) diorganopolysiloxane is exemplified by polydimethylsiloxanes endblocked at both molecular chain terminals by dimethylvinylsiloxy groups, dimethylsiloxane•methylvinylsiloxane copolymers endblocked at both molecular chain terminals by dimethylvinylsiloxy groups, methylvinylpolysiloxanes endblocked at both molecular chain terminals by trimethylsiloxy groups, dimethylsiloxane•methylvinylsiloxane copolymers endblocked at both molecular chain terminals by trimethylsiloxy groups, and mixtures of two or more of the preceding.

The content of component (A-1) in the present composition is an amount that is 65 to 90 mass % of component (A) and preferably is an amount that is 75 to 85 mass % of component (A). The reasons for this are as follows: when the component (A-1) content is less than the lower limit on the cited range, the flexibility of the cured silicone material provided by the cure of the present composition tends to decline; when, on the other hand, the component (A-1) content exceeds the upper limit on the cited range, the physical properties of the cured silicone material provided by the cure of the present composition tend to decline and the surface releasability tends to deteriorate.

The alkenyl-containing, resin-form organopolysiloxane that is component (A-2) imparts a satisfactory adhesiveness to substrate, strength, flexibility, and surface releasability to the cured silicone material provided by the cure of the present composition and comprises the SiO_{4/2} unit, R¹₂R²SiO_{1/2} unit, and R¹₃SiO_{1/2} unit. In these formulas, R¹ is C₁₋₁₀ alkyl such as methyl, ethyl, propyl, cyclopentyl, cyclohexyl, and so forth, and R² is an alkenyl group such as vinyl, allyl, isopropenyl, butenyl, hexenyl, cyclohexenyl, and so forth, wherein vinyl is preferred.

The component (A-2) alkenyl-containing, resin-form organopolysiloxane contains the alkenyl group in the range from more than 2.5 mass % to not more than 5.0 mass % and preferably contains 3.5 to 5.0 mass % alkenyl. The reasons for this are as follows: when the alkenyl content in component (A-2) is less than the cited lower limit, the surface releasability of the cured silicone material provided by the cure of the present composition tends to be unsatisfactory; when, on the other hand, the alkenyl content in component (A-2) exceeds the cited upper limit, the flexibility of the cured silicone material provided by the cure of the present composition tends to decline. Component (A-2) may be a mixture of two or more alkenyl-containing, resin-form organopolysiloxanes, in which case the mixture considered as such must contain alkenyl in the range from more than 2.5 mass % to not more than 5.0 mass %.

The ratio of the total number of moles of R¹₂R²SiO_{1/2} and R¹₃SiO_{1/2} units to 1 mole of the SiO_{4/2} unit in component (A-2) is preferably in the range from 0.5 to 1.4, more preferably in the range from 0.5 to 1.2, and particularly preferably in the range from 0.6 to 1.0. The reasons for this are as follows: when the ratio of the total number of moles of R¹₂R²SiO_{1/2} and R¹₃SiO_{1/2} units to 1 mole of the SiO_{4/2} unit in component (A-2) is less than the cited lower limit, the present composition will have an excessively high viscosity, which can cause a decline in the handling characteristics and can cause a decline in the surface releasability of the cured silicone material provided by the cure of the present composition; when, on the other hand, the ratio of the total number of moles of R¹₂R²SiO_{1/2} and R¹₃SiO_{1/2} units to 1 mole of the SiO_{4/2} unit in component (A-2) exceeds the upper limit cited above, the cured silicone material provided by the cure of the present composition may have an unsatisfactory flexibility. Component (A-2) may be a mixture of two or more alkenyl-containing, resin-form organopolysiloxanes and is preferably a mixture comprising alkenyl-containing, resin-form organopolysiloxanes that have a ratio for the total number of moles of R¹₂R²SiO_{1/2} and R¹₃SiO_{1/2} units to 1 mole of the SiO_{4/2} unit in the range from 0.5 to 1.4.

Component (A-2) has a mass-average molecular weight, on a standard polystyrene basis by gel permeation chromatography, preferably in the range from 3,000 to 7,000 and more preferably in the range from 4,000 to 6,000. Component (A-2) may be a mixture of two or more alkenyl-containing, resin-form organopolysiloxanes and is preferably a mixture comprising alkenyl-containing, resin-form organopolysiloxanes that have a mass-average molecular weight, on a standard polystyrene basis by gel permeation chromatography, in the range from 3,000 to 7,000.

The content of component (A-2) in the present composition is an amount that is 10 to 35 mass % of component (A) and preferably is an amount that is 15 to 30 mass % of component (A). The reasons for this are as follows: when the component (A-2) content is less than the lower limit on the cited range, the surface releasability of the cured silicone material provided by the cure of the present composition tends to decline; when, on the other hand, the component (A-2) content exceeds the upper limit on the cited range, the flexibility of the cured silicone material provided by the cure of the present composition tends to decline, while the viscosity of the present composition undergoes an overly large increase and the handling characteristics tend to decline as a result.

The organopolysiloxane that is component (B) is a crosslinking agent for the present composition. The molecular structure of component (B) can be, for example, straight chain, partially branched straight chain, branched chain, cyclic, or dendritic wherein straight chain, partially branched straight chain, and dendritic are preferred. There are no limitations on the bonding position of the silicon-bonded hydrogen in component (B), and the silicon-bonded hydrogen may be bonded in, for example, terminal position on the molecular chain and/or side chain position on the molecular chain. The silicon-bonded groups in component (B) other than the silicon-bonded hydrogen are alkyl such as methyl, ethyl, propyl, cyclopentyl, cyclohexyl, and so forth, wherein methyl is preferred. This provides a good compatibility with component (A) and also provides an excellent surface releasability for the cured silicone material provided by the cure of the present composition. While there is no limitation on the viscosity of component (B), its viscosity at 25° C. is preferably in the range from 1 to 10,000 mm²/s and particularly preferably is in the range from 1 to 1,000 mm²/s. Moreover, component (B) preferably contains at least 0.7 mass % silicon-bonded hydrogen from the standpoint of improving the surface releasability of the present composition.

An example of a particularly preferred component (B) is an organopolysiloxane comprising (B-1) an organopolysiloxane that contains at least 0.7 mass % silicon-bonded hydrogen and that comprises the SiO_{4/2} unit and HR³₂SiO_{1/2} unit wherein R³ is C₁₋₁₀ alkyl such as methyl, ethyl, propyl, cyclopentyl, cyclohexyl, and so forth, with methyl being preferred, at 50 to 100 mass % of component (B), and (B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B). Component (B-2) preferably contains at least 0.7 mass % silicon-bonded hydrogen.

In addition to the SiO_{4/2} unit and HR³₂SiO_{1/2} unit, component (B-1) may also contain the R³₃SiO_{1/2} unit. The ratio of the total number of moles of HR³₂SiO_{1/2} and R³₃SiO_{1/2} units to 1 mole of the SiO_{4/2} unit in component (B-1) is preferably in the range from 1.5 to 2.5 and more preferably is in the range from 1.8 to 2.2. A specific example of a preferred component (B-1) is the organopolysiloxane with the formula (SiO_{4/2})₄(H(CH₃)₂SiO_{1/2})₈.

The component (B-2) straight-chain organopolysiloxane contains at least 0.3 mass % and preferably at least 0.7 mass % silicon-bonded hydrogen. The silicon-bonded groups other than the silicon-bonded hydrogen are C₁₋₁₀ alkyl such as methyl, ethyl, propyl, cyclopentyl, cyclohexyl, and so forth, wherein methyl is preferred. Component (B-2) has a substantially straight chain molecular structure, but a portion of the molecular chain may be somewhat branched. Preferred specific examples of component (B-2) are dimethylsiloxane•methylhydrogensiloxane copolymers endblocked at both molecular chain terminals by dimethylhydrogensiloxy groups, methylhydrogenpolysiloxanes endblocked at both molecular chain terminals by trimethylsiloxy groups, dimethylsiloxane•methylhydrogensiloxane copolymers endblocked at both molecular chain terminals by trimethylsiloxy groups, and mixtures of two or more of the preceding.

The content of component (B) in the present composition is an amount that provides from 0.5 to 5 moles and preferably from 0.7 to 2.5 moles silicon-bonded hydrogen atoms in this component per 1 mole of the total alkenyl in component (A). The reasons for this are as follows: when the component (B) content is less than the lower limit for the cited range, curing of the composition tends to be unsatisfactory; when, on the other hand, the upper limit for the cited range is exceeded, the flexibility and/or surface releasability of the cured silicone material provided by the cure of the present composition may be diminished.

The hydrosilylation reaction catalyst that is component (C) is a catalyst for promoting curing of the present composition and can be exemplified by platinum-type catalysts, rhodium-type catalysts, and palladium-type catalysts, wherein the platinum-type catalysts are particularly preferred. These platinum-type catalysts can be exemplified by platinum micropowder, platinum black, platinum supported on silica micropowder, platinum supported on active carbon, chloroplatinic acid, alcohol solutions of chloroplatinic acid, and platinum compounds such as olefin complexes of platinum, alkenylsiloxane complexes of platinum, and so forth.

The component (C) content in the present composition is a catalytic quantity and in specific terms is a quantity that provides 0.01 to 1,000 mass-ppm catalyst metal atoms with reference to the present composition. The reasons for this are as follows: when the component (C) content is less than the lower limit for the cited range, the risk arises that the cure of the resulting composition will not proceed adequately; on the other hand, curing is not significantly promoted by exceeding the upper limit for the cited range, while the risk arises that problems will appear such as discoloration of the cured silicone material.

As other, optional components, the present composition may contain, for example, a reaction inhibitor in order to adjust the cure rate of the present composition, e.g., an alkyne alcohol such as 2-methyl-3-butyn-2-ol, 3,5-dimethyl-1-hexyn-3-ol, 1-ethynyl-1-cyclohexanol, phenylbutynol, and so forth; ene-yne compounds such as 3-methyl-3-penten-1-yne, 3,5-dimethyl-3-hexen-1-yne, and so forth; as well as 1,3,5,7-tetramethyl-1,3,5,7-tetravinylcyclotetrasiloxane, 1,3,5,7-tetramethyl-1,3,5,7-tetrahexenylcyclotetrasiloxane, benzotriazole, and so forth. There is no limitation on the content of this reaction inhibitor in the present composition, and this content may be selected as appropriate as a function of the molding method and curing conditions; however, an amount within the range from 10 to 5,000 mass-ppm with reference to the present composition is generally preferred.

The present composition may incorporate, insofar as the object of the present invention is not impaired, for example, an adhesion promoter, flame retardant, inorganic filler, colorant, static inhibitor such as carbon black, an agent that provides electroconductivity, and so forth. However, as a general matter, preferably neither an adhesion promoter nor an inorganic filler is incorporated from the standpoint of the surface releasability of the cured silicone material provided by the cure of the present composition.

When the cured silicone material provided by the cure of the present composition is to be used in electrical•electronic applications, the content in the present composition of low molecular weight organopolysiloxane, i.e., the tetramer to decamer on a siloxane unit basis, is preferably not more than 350 ppm.

The viscosity of the present composition at 25° C. is not particularly limited, but considered from the standpoint of the moldability and handling characteristics, i.e., ease of pouring or injection, ease of degassing, and so forth, the viscosity of the present composition at 25° C. is preferably 2 to 100 Pa·s and particularly preferably is 5 to 50 Pa·s. The present composition can be suitably used as a cured coating-forming coating agent for forming a cured silicone layer on the surface of a substrate, infra.

The present composition forms a cured silicone material when cured by heating to 100 to 250° C. This cured silicone material according to the present invention has a hardness, as measured using the type A durometer specified in JIS K 6253, of not more than 75, preferably in the range from 30 to 70, and more preferably in the range from 40 to 65. The reason for this is as follows: when the upper limit for the cited range is exceeded, the flexibility of the cured silicone material under consideration tends to be inadequate.

The cured silicone material provided by the cure of the present composition must have an elongation as specified in JIS K 6251 of at least 35% from the standpoint of the flexibility.

The cured silicone material provided by the cure of the present composition may be a composite in which the cured silicone material is made into a single article with any of various substrates. Such a cured silicone composite can be produced by coating the present composition on a substrate and then thermosetting to form a cured silicone layer on the surface of the substrate. The substrate can be exemplified by metals such as iron, aluminum, copper, nickel plating, and so forth; thermoplastic plastics such as polyethylene terephthalate resin, polybutylene terephthalate resin, polyurethane resin, ABS resin, polycarbonate resin, polyamide resin, polyimide resin, and so forth; thermoplastic elastomers such as styrene types, polyester types, and polyurethane types; thermosetting plastics such as epoxy resins, phenolic resins, and so forth; rubbers such as polyisobutyl rubbers, acrylic rubbers, EPDM, silicone rubbers, and so forth; backing fabrics such as those made of nylon or polyester; electronic parts and components; and light-emitting elements. Preferred thereamong are substrates that are flexible, low hardness elastic materials such as silicone rubbers, silicone gels, silicone sealants, and so forth. There are no particular limitations on these silicone elastomers, which may be the cured product from a condensation reaction curable silicone elastomer composition, a peroxide curable silicone elastomer composition, or a hydrosilylation reaction-based addition curable silicone elastomer composition, or may be the cured product from a millable silicone rubber composition, or may be the cured product from a liquid silicone elastomer composition. The present composition characteristically exhibits an excellent adhesion to silicone elastomers and an excellent adhesion even to hydrosilylation reaction-based addition curable silicone elastomers, which have heretofore been refractory to adhesion.

The aforementioned cured silicone composite can be exemplified by a roller or belt in which a cured silicone layer provided by the cure of the present composition is formed into a single article as a surface release layer on the peripheral surface of a silicone elastomer that is formed on the periphery of a core or belt substrate. This roller or belt can be produced by forming a silicone elastomer layer on the periphery of a core or belt substrate; coating the present composition on the peripheral surface of this silicone elastomer layer; and then thermosetting to form a cured silicone layer that functions as a surface release layer. Known methods can be used to coat the present composition on the silicone elastomer layer, and the cured silicone layer provided by the cure of the present composition can also be formed as a surface release layer by casting using a mold or die. In addition, the present composition may as necessary be diluted with any of various solvents in order to change the viscosity and/or fluidity of the present composition.

The cured silicone material provided by the cure of the present composition has a relatively low hardness and is flexible, which as a consequence characteristically makes it possible to provide a roller or belt that has a low surface hardness and does not lose the flexibility of the underlying elastomer layer. Such a roller or belt can be suitably used as a roller or belt for use in a fixing section, e.g., as a pressure roller, heat roller, and so forth.

### EXAMPLES

### Examples 1 to 5

The materials shown in Table 1 were mixed to uniformity in the quantity proportions shown in Table 1 to produce curable silicone rubber compositions. The resulting compositions were press cured for 10 minutes at 120° C. and were then held for an additional 4 hours in a 200° C. oven to produce the 2 mm-thick cured sheet. The resulting cured sheet was used to measure the hardness, tensile strength, elongation, and peeling resistance in accordance with the following methods. The results are given in Table 1.

Test, Measurement, and Evaluation Methods

The properties (hardness, tensile strength, elongation, and peeling resistance) of the cured silicone material were measured using the following methods.

### (1) Hardness

The hardness was measured using the type A durometer specified in JIS K 6253.

### (2) Tensile Strength and Elongation

The tensile strength and elongation were measured according to the methods specified in JIS K 6251.

### (3) Peeling Resistance

A vinyl tape (trade name: Eslon R No. 360, Sekisui Chemical Co., Ltd.) was pasted with the exclusion of air bubbles on the 2 mm-thick test specimen. This vinyl tape was a polyvinyl chloride pressure-sensitive adhesive tape for electrical insulation service and had a tape width of 19 mm and a length of 150 mm. The average value of the peeling resistance was measured when a 90 mm in length peel of this vinyl tape was executed at a peel rate of 50 mm/min using a Shimadzu Autograph AGS-50D from Shimadzu Seisakusho. The average value of the peeling resistance was also measured when a 90 mm peel in length of this vinyl tape was executed at a peel rate of 6000 mm/min using a high-speed lightweight peeling test instrument from Tester Sangyo Co., Ltd.

The nature and designation of the materials used as components (A)-(C) and the other components in Tables 1 and 2 are as follows. Here, Vi designates the vinyl group while Me designates the methyl group. In addition, the viscosity is the value at 25° C. and parts indicates mass parts.

### Component A-1

a-1: a polydimethylsiloxane endblocked by dimethylvinylsiloxy groups at both molecular chain terminals, that has a viscosity of 40,000 mPa·s and a vinyl group content of 0.09 mass %.

a-2: a polydimethylsiloxane endblocked by dimethylvinylsiloxy groups at both molecular chain terminals, that has a viscosity of 11,000 mPa·s and a vinyl group content of 0.14 mass %. This polydimethylsiloxane had been treated to reduce its content of low molecular weight components and had a content of tetrameric to decameric, considered in terms of the siloxane unit, low molecular weight organopolysiloxane of not more than 200 ppm.

a-3: a polydimethylsiloxane endblocked by dimethylvinylsiloxy groups at both molecular chain terminals, that has a viscosity of 2,000 mPa·s and a vinyl group content of 0.23 mass %.

a-4: a polydimethylsiloxane endblocked by dimethylvinylsiloxy groups at both molecular chain terminals, that has a viscosity of 400 mPa·s and a vinyl group content of 0.48 mass %.

a-5: a dimethylsiloxane•methylvinylsiloxane copolymer endblocked by dimethylvinylsiloxy groups at both molecular chain terminals, that has a viscosity of 15,000 mPa·s and a vinyl group content of 7.7 mass %.

a-6: a polydimethylsiloxane gum endblocked by dimethylvinylsiloxy groups at both molecular chain terminals, that has a viscosity of at least 1,000,000 mPa·s and a vinyl group content of 0.017 mass %.

a-7: a dimethylsiloxane methylvinylsiloxane copolymer endblocked by trimethylsiloxy groups at both molecular chain terminals, that has a viscosity of 40,000 mPa·s and a vinyl group content of 0.50 mass %.

a-8: a dimethylsiloxane•methylvinylsiloxane copolymer endblocked by trimethylsiloxy groups at both molecular chain terminals, that has a viscosity of 8,000 mPa·s and a vinyl group content of 0.30 mass %. This dimethylsiloxane•methylvinylsiloxane copolymer had been treated to reduce its content of low molecular weight components and had a content of tetrameric to decameric, considered in terms of the siloxane unit, low molecular weight organopolysiloxane of not more than 200 ppm.

Component A-2

a-9: an organopolysiloxane given by the average unit formula (ViMe₂SiO_{1/2})_{0.11}(Me₃SiO_{1/2})_{0.33}(SiO_{4/2})_{0.57}, that has a mass-average molecular weight of approximately 4,600 and a vinyl group content of 4.0 mass %.

a-10: an organopolysiloxane given by the average unit formula (ViMe₂SiO_{1/2})_{0.04} (Me₃SiO_{1/2})_{0.40}(SiO_{4/2})_{0.56}, that has a mass-average molecular weight of approximately 4,600 and a vinyl group content of 1.5 mass %.

a-11: an organopolysiloxane given by the average unit formula (ViMe₂SiO_{1/2})_{0.14} (Me₃SiO_{1/2})_{0.48}(SiO_{4/2})_{0.39}, that has a mass-average molecular weight of approximately 2,500 and a vinyl group content of 5.0 mass %.

Component B

b-1: an organopolysiloxane given by the average unit formula (HMe₂SiO_{1/2})₈(SiO_{4/2})₄, that has a kinematic viscosity of 18 mm²/s and a silicon-bonded hydrogen atom content of approximately 0.97 mass %.

b-2: a dimethylsiloxane•methylhydrogensiloxane copolymer endblocked by trimethylsiloxy groups at both molecular chain terminals, that has a kinematic viscosity of 15 mm²/s and a silicon-bonded hydrogen atom content of approximately 0.83 mass %.

Component C

platinum catalyst: a 1,3-divinyltetramethyldisiloxane solution of a 1,3-divinyltetramethyldisiloxane complex of platinum. The platinum metal content is approximately 6500 ppm.

### Reaction Inhibitor as a Cure Retarder

1-ethynyl-1-cyclohexanol

### Iron Oxide Micropowder Paste

A paste in which an iron oxide micropowder is dispersed, comprising 50 parts iron oxide inorganic micropowder (trade name: Bayferrox from Bayer AG) and 50 parts of a polydimethylsiloxane endblocked by dimethylvinylsiloxy groups at both molecular chain terminals and having a viscosity of 11,000 mPa·s and a vinyl group content of 0.14 mass %.

### Silica Masterbatch

A flowable silica masterbatch was prepared by introducing 5 mass parts hexamethyldisilazane, 45 mass parts fumed silica having a BET specific surface area of 200 m²/g, and 100 mass parts of a dimethylpolysiloxane endblocked by dimethylvinylsiloxy groups at both molecular chain terminals and having a viscosity of 11,000 mPa·s and a vinyl group content of 0.14 mass %, into a planetary mixer; mixing to uniformity at room temperature; and thereafter heating for 2 hours at 200° C. under reduced pressure.

TABLE 1

| | | Exam- | Exam- | Exam- | Exam- | Exam- |
|---|---|---|---|---|---|---|
| | | ple 1 | ple 2 | ple 3 | ple 4 | ple 5 |
| silica masterbatch (parts) | | | | | | |
| A-1 | a-1 (parts) | 22 | | | | |
| | a-2 (parts) | 15 | 80 | 30 | 30 | 30 |
| | a-3 (parts) | | | | | |
| | a-4 (parts) | 35 | | 50 | | |
| | a-5 (parts) | 10 | | | | |
| | a-6 (parts) | | | | | |
| | a-7 (parts) | | | | 50 | |
| | a-8 (parts) | | | | | 50 |
| A-2 | a-9 (parts) | 10 | 20 | 20 | 20 | 20 |
| | a-10 (parts) | 8 | | | | |
| | a-11 (parts) | | | | | |
| B | b-1 (parts) | 6.0 | 3.9 | 4.6 | 4.6 | 4.2 |
| | b-2 (parts) | 4.0 | 2.2 | 2.7 | 2.7 | 2.5 |
| C | platinum | 0.1 | 0.1 | 0.1 | 0.1 | 0.1 |
| | catalyst | | | | | |
| | (parts) | | | | | |

| | | | | | |
|---|---|---|---|---|---|
| reaction inhibitor (parts) | 0.05 | 0.05 | 0.05 | 0.05 | 0.05 |
| iron oxide micropowder | 1 | 1 | | | 1 |
| paste (parts) | | | | | |
| hardness (JIS A) | 64 | 55 | 59 | 63 | 58 |
| tensile strength (MPa) | 2.9 | 7.2 | 7.8 | 3.5 | 5.0 |
| elongation (%) | 41 | 150 | 96 | 43 | 67 |
| peeling resistance | | | | | |
| (g/19 mm) | | | | | |
| 6000 mm/min. peeling | 40 | 44 | 30 | 28 | 28 |
| rate | | | | | |
| 50 mm/min. peeling rate | 6 | 7 | 6 | 7 | 6 |

### Comparative Examples 1 to 3

The materials shown in Table 2 were mixed to uniformity in the quantity proportions shown in Table 2 to produce curable silicone rubber compositions. The resulting compositions were press cured for 10 minutes at 120° C. and were then held for an additional 4 hours in a 200° C. oven to produce the 2 mm-thick cured sheet. The resulting cured sheet was used to measure the tensile strength, elongation, and peeling resistance. The results are given in Table 2.

TABLE 2

| | | Compara- | Compara- | Compara- |
|---|---|---|---|---|
| | | tive | tive | tive |
| | | Example 1 | Example 2 | Example 3 |
| silica masterbatch (parts) | | | 50 | |
| A-1 | a-1 (parts) | 38 | | |
| | a-2 (parts) | | 66 | |
| | a-3 (parts) | 26 | | 21 |
| | a-4 (parts) | | | 40 |
| | a-5 (parts) | 9 | | 8 |
| | a-6 (parts) | | | 10 |
| | a-7 (parts) | | | |
| | a-8 (parts) | | | |
| A-2 | a-9 (parts) | | | |
| | a-10 (parts) | 27 | | 11 |
| | a-11 (parts) | | | 10 |
| B | b-1 (parts) | 8.8 | 0.8 | 6.5 |
| | b-2 (parts) | | | 3.9 |
| C | platinum catalyst (parts) | 0.2 | 0.2 | 0.1 |

| | | | |
|---|---|---|---|
| reaction inhibitor (parts) | 0.05 | 0.03 | 0.06 |
| iron oxide micropowder paste (parts) | | 2 | 1 |
| hardness (JIS A) | 63 | 25 | 53 |
| tensile strength (MPa) | 6.8 | 3.5 | 2.6 |
| elongation (%) | 78 | 475 | 67 |
| peeling resistance (g/19 mm) | | | |
| 6000 mm/min. peeling rate | 74 | 145 | 95 |
| 50 mm/min. peeling rate | 12 | 9 | 9 |

### Example 6

The following were introduced into a planetary mixer and mixed for 2 hours: 30 parts quartz powder (Tatsumori Co., Ltd.) with an average particle size of 5 μm, 3 parts surface-hydrophobed fumed silica (Nippon Aerosil) having a BET specific surface area of 110 m²/g, and 100 parts of a dimethylsiloxane•methylvinylsiloxane copolymer endblocked by trimethylsiloxy groups at both molecular chain terminals and having a viscosity of 40,000 mPa·s and a vinyl group content of approximately 0.12 mass %. To this were added 1.2 parts of a dimethylsiloxane•methylhydrogensiloxane copolymer endblocked at both molecular chain terminals by dimethylhydrogensiloxy groups and having a silicon-bonded hydrogen content of approximately 0.4 mass %, 0.05 part 1-ethynyl-1-cyclohexanol, and 0.25 part isopropanolic chloroplatinic acid solution having a platinum concentration of 0.7%, and stirring was performed for 30 minutes. The resulting composition was poured into a 6 mm-thick mold and press cured for 10 minutes at 120° C. followed by holding for 4 hours in a 200° C. oven to produce a cured silicone rubber test specimen. The Asker C hardness of the resulting cured silicone rubber test specimen was 22. Here and below, the Asker C hardness corresponds to the test method using a type C hardness tester that is specified in JIS K 7312. The curable silicone rubber composition of Example 3, which is described in Table 1, was coated so as to provide a thickness of 500 μm on the surface of the obtained cured silicone rubber test specimen followed by curing for 15 minutes in an oven at 150° C. The resulting cured silicone material/silicone rubber composite had an Asker C hardness of 29. A cured silicone material/silicone rubber composite fabricated in the same manner, but changing the thickness of the silicone rubber composition to 300 μm, had an Asker C hardness of 25.

The obtained cured silicone material/silicone rubber composite was tightly integrated into a single article: separation was not seen even when the surface of the cured silicone material layer was scraped with a metal spatula; moreover, when the cured silicone material was peeled off with a Tensilon, the peel surface presented cohesive failure. Abnormalities in the cured silicone material layer, such as peeling, rupture, whitening, and so forth, were also not seen when the obtained cured silicone material/silicone rubber composite was bent 180°. In addition, the surface of the cured silicone material coating of the obtained cured silicone material/silicone rubber composite was entirely free of tackiness to finger contact.

### Comparative Example 4

The following were introduced into a planetary mixer and mixed for 2 hours: 30 parts quartz powder (Tatsumori Co., Ltd.) with an average particle size of 5 μm, 3 parts surface-hydrophobed fumed silica (Nippon Aerosil) having a BET specific surface area of 110 m²/g, and 100 parts of a dimethylsiloxane•methylvinylsiloxane copolymer endblocked by trimethylsiloxy groups at both molecular chain terminals and having a viscosity of 40,000 mPa·s and a vinyl group content of approximately 0.12 mass %. To this were added 1.2 parts of a dimethylsiloxane•methylhydrogensiloxane copolymer endblocked at both molecular chain terminals by dimethylhydrogensiloxy groups and having a silicon-bonded hydrogen content of approximately 0.4 mass %, 0.05 weight part 1-ethynyl-1-cyclohexanol, and 0.25 part isopropanolic chloroplatinic acid solution having a platinum concentration of 0.7%, and stirring was performed for 30 minutes, thereby providing a curable silicone rubber composition.

A 6 cm wide by 10 cm long sheet was cut from a 50 μm-thick PFA tube (trade name: NSE, from Gunze Limited) and a primer (trade name: DY39-067, from Dow Corning Toray Co., Ltd.) was coated on the side of this sheet that had been treated to improve its wettability, and drying was then carried out at room temperature. The aforementioned curable silicone rubber composition was cast onto the primed surface of the PFA sheet so as to provide a thickness of 6 mm followed by press curing for 10 minutes at 120° C. and then holding for 4 hours in a 200° C. oven to produce a PFA-coated cured silicone rubber test specimen. The resulting test specimen had an Asker C hardness of 39.

### INDUSTRIAL APPLICABILITY

The curable silicone rubber composition of the present invention, when cured, forms a flexible cured silicone material that has an excellent surface releasability. As a result, when it is coated on the surface of any of various substrates and then cured by heating, it can form on the surface of the substrate a flexible cured silicone layer that is integrated into a single article with the substrate, that has an excellent surface releasability, and that is tack-free. Because of this, the curable silicone rubber composition of the present invention is useful as a coating material or surface layer material for highly flexible substrates and low-hardness substrates, e.g., silicone elastomers such as silicone rubbers, silicone gels, silicone sealants, and so forth; polyurethane resins; and nylon and polyester backing fabrics. For example, the curable silicone rubber composition of the present invention is well suited for use, inter alia, for the surface layer material of silicone rubber rollers, such as fixing rollers where toner releasability is required; for the surface layer material of silicone gels where shape retention and prevention of tackiness are required; as a coating material in order to prevent the fouling of low-hardness packings and bushings; and as a surface layer material or ink for silicone rubber keypads.

1. A curable silicone rubber composition characteristically comprising
(A) 100 mass parts of an alkenyl-containing organopolysiloxane comprising
(A-1) a dialkylpolysiloxane that has an average of at least two alkenyl groups in each molecule and a viscosity at 25° C. of 300 to 100,000 mPa·s, at 65 to 90 mass % of component (A), and
(A-2) an alkenyl-containing, resin-form organopolysiloxane that comprises the SiO_{4/2} unit, R¹₂R²SiO_{1/2} unit, and R¹₃SiO_{1/2} unit wherein R¹ is C₁₋₁₀ alkyl and R² is alkenyl and that contains the alkenyl group in the range from more than 2.5 mass % to not more than 5.0 mass %, at 10 to 35 mass % of component (A);
(B) an organopolysiloxane that has an average of at least two silicon-bonded hydrogen atoms in each molecule wherein the silicon-bonded groups other than the silicon-bonded hydrogen are C₁₋₁₀ alkyl, in an amount that provides 0.5 to 5 moles silicon-bonded hydrogen in this component per 1 mole of the total alkenyl in component (A); and
(C) a hydrosilylation reaction catalyst in a catalytic quantity,
and provides a cured silicone material that has a hardness measured using the type A durometer specified in JIS K 6253 is not more than 75 and the elongation specified in JIS K 6251 is at least 35%.

2. The curable silicone rubber composition according to claim 1, wherein component (B) is an organopolysiloxane comprising
(B-1) an organopolysiloxane that contains at least 0.7 mass % silicon-bonded hydrogen and that comprises the SiO_{4/2} unit and HR³₂SiO_{1/2} unit wherein R³ is C₁₋₁₀ alkyl, at 50 to 100 mass % of component (B), and
(B-2) a straight-chain organopolysiloxane that contains at least 0.3 mass % silicon-bonded hydrogen wherein the silicon-bonded groups other than the silicon-bonded hydrogen are C₁₋₁₀ alkyl, at 0 to 50 mass % of component (B).

3. The curable silicone rubber composition according to claim 1, wherein the ratio of the total number of moles of R¹₂R²SiO_{1/2} and R¹₃SiO_{1/2} units to 1 mole of the SiO_{4/2} unit in component (A-2) is in the range from 0.5 to 1.4.

4. A cured coating layer-formable coating agent comprising the curable silicone rubber composition according to claim 1.

5. A cured silicone composite comprising a cured silicone layer that forms a single article with the surface of a substrate wherein the cured silicone layer is provided by the thermosetting of a curable silicone rubber composition according to claim 1.

6. The cured silicone composite according to claim 5, wherein the substrate is a silicone elastomer.

7. A roller or belt characterized in that a cured silicone layer is formed on a peripheral surface of a silicone elastomer layer that is formed on the periphery of a core or belt substrate wherein the cured silicone layer is provided by the thermosetting of a curable silicone rubber composition according to claim 1.

8. A method of producing a cured silicone composite, comprising coating a curable silicone rubber composition according to claim 1 on a substrate; and then carrying out thermosetting to form a cured silicone layer on the surface of the substrate.

9. The method of producing a cured silicone composite according to claim 8, wherein the substrate is a silicone elastomer.

10. A method of producing a roller or belt, comprising coating the curable silicone rubber composition according to claim 1 on a peripheral surface of a silicone elastomer layer formed on the periphery of a core or belt substrate; and then thermosetting to form a cured silicone layer on the peripheral surface of the silicone elastomer layer.

11. The curable silicone rubber composition according to claim 2, wherein the ratio of the total number of moles of R¹₂R²SiO_{1/2} and R¹₃SiO_{1/2} units to 1 mole of the SiO_{4/2} unit in component (A-2) is in the range from 0.5 to 1.4.
